(19) United States
(12) Patent Application Publication
(10) Pub. No.: US 2022/0207503 A1
(43) Pub. Date: Jun. 30, 2022

(54) METHOD AND DEVICE TO PROVIDE MULTI-SUBSCRIPTION SERVICE

(71) Applicant: KAKAO CORP., Jeju-si (KR)

(72) Inventors: Woo Ri PARK, Seongnam-si (KR); Jason SHIM, Seongnam-si (KR); O Seok HAN, Seongnam-si (KR); Dong Jun KIM, Seongnam-si (KR); Ki Hyun KIM, Seongnam-si (KR)

(21) Appl. No.: 17/564,222

(22) Filed: Dec. 29, 2021

(30) Foreign Application Priority Data
Dec. 31, 2020 (KR) 10-2020-0189258

(51) Int. Cl. G06Q 20/14; G06Q 50/00; G06F 16/953; H04W 4/35

(52) U.S. Cl. CPC G06Q 20/14; H04W 4/35; G06F 16/953; G06Q 50/01

(57) ABSTRACT

Disclosed is a server and a method for providing a multi-subscription service. The method performed by the server includes receiving a subscription request for a target merchandise from a user terminal, querying another merchandise to which a user account is subscribing in response to the subscription request being received, determining a usage period of the target merchandise for which a subscription is requested based on a usage period of the other merchandise in response to the other merchandise being queried, calculating a payment amount for an initial subscription of the target merchandise based on the determined usage period, requesting a payment of the calculated payment amount by the user terminal, and providing the target merchandise to the user terminal in response to the payment by the user terminal being approved.

### CROSS-REFERENCE TO RELATED APPLICATION

This application claims the benefit of Korean Patent Application No. 10-2020-0189258 filed on Dec. 31, 2020, in the Korean Intellectual Property Office, the entire disclosure of which is incorporated herein by reference for all purposes.

### BACKGROUND

### 1. Field of the Invention

One or more of example embodiments relates to a method and device for providing a multi-subscription service, and more particularly, to a server and an operating method thereof to for providing a multi-subscription service in a social networking service (SNS) server and an instant messaging service (IMS) server.

### 2. Description of the Related Art

Recently, online platform services are increasingly being used for interaction between users through a network due to developments in mobile smart devices. Typical examples of online platform services for interaction between users may include a social networking service (SNS), which is an online platform that creates and strengthens social relationships through communication, information sharing, and network expansion between users, and an instant messaging service (IMS), which is an online platform for real-time content communication between two or more users. SNS and IMS platforms may also provide a subscription service for various merchandises.

### SUMMARY

According to an aspect, there is provided a method of providing a multi-subscription service performed by a server including receiving a subscription request for a target merchandise from a user terminal, querying another merchandise to which a user account is subscribing in response to the subscription request being received, determining a usage period of the target merchandise for which a subscription is requested based on a usage period of the other merchandise in response to the other merchandise being queried, calculating a payment amount for an initial subscription of the target merchandise based on the determined usage period, requesting a payment of the calculated payment amount by the user terminal, and providing the target merchandise to the user terminal in response to the payment by the user terminal being approved.

The determining of the usage period may include determining an end date of the usage period of the target merchandise to be a same date as an end date of the usage period of the queried other merchandise.

The requesting of the payment of the calculated payment amount may include calculating the payment amount for the initial subscription of the target merchandise based on a subscription charge determined for a preset period of the target merchandise and a period from a subscription start date of the target merchandise to an end date of the usage period of the target merchandise.

The end date of the usage period of the other merchandise may be determined based on one of a payment date determined by a user or a payment date determined by a server.

The receiving of the subscription request may include accepting the subscription request for the target merchandise in response to an authentication of the user account.

The accepting of the subscription request may include accepting the subscription request in a period after a certificate used for the authentication of user account has expired and before the certificate is renewed.

The method may further include exposing a merchandise available to he subscribed to by the user account among a plurality of merchandises by being associated with a profile interface of the user account.

The method may further include stopping a provision of a merchandise to which the user account is subscribing, while keeping subscription information associated with the merchandise to which the user account is subscribing in response to a payment failure by a payment method registered in the user account on a regular payment date.

The requesting of the payment of the calculated payment amount may include determining a first discount rate for the initial subscription based on a subscription combination of the target merchandise and the other merchandise to which the user account is subscribing, and requesting a payment amount obtained by applying the first discount rate to the payment amount for the initial subscription of the target merchandise. The method may further include determining a second discount rate for a regular subscription based on the subscription combination of the target merchandise and the other merchandise to which the user account is subscribing, and requesting a payment amount obtained by applying the second discount rate to a payment amount for the regular subscription of the subscription combination regularly.

According to another aspect, there is provided a method of providing a multi-subscription service performed by a user terminal including transmitting a subscription request for a target merchandise of a user account to a server, performing a process of paying a payment amount for an initial subscription of the target merchandise, and providing the target merchandise to the user terminal in response to a payment by the user terminal being approved. A usage period of the target merchandise for which a subscription is requested may be determined based on a usage period of another merchandise to which the user account is subscribing and be calculated based on a determined usage period for the target merchandise in response to the subscription request.

The performing of the payment process may include outputting the payment amount for the initial subscription of the target merchandise with the usage period of the target merchandise, and outputting a payment amount for a regular subscription for the target merchandise with a subsequent regular payment date after the initial subscription. The payment amount for the initial subscription of the target merchandise may be calculated based on a subscription charge determined for the target merchandise for a preset period and a period from a subscription start date of the target merchandise to an end date of the usage period of the target merchandise.

According to another aspect, there is provided a server for providing a multi-subscription service including a communicator configured to receive a subscription request for a target merchandise from a user terminal, a memory configured to store subscription information associated with a subscription of the user terminal, and a processor. The processor may query another merchandise to which a user account is subscribing in response to the subscription request being received, determine a usage period of the target merchandise for which a subscription is requested based on a usage period for the queried other merchandise in response to the other merchandise being queried, calculate a payment amount for an initial subscription of the target merchandise based on the determined usage period, request a payment of the calculated payment amount by the user terminal, and provide the target merchandise to the user terminal in response to the payment by the user terminal being approved.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of a method of providing a multi-subscription service according to an example embodiment;

FIG. 2 is a diagram illustrating an example of a method of providing a multi-subscription service according to an example embodiment;

FIG. 3 is a diagram illustrating an example of determining a payment amount and a payment date of an initial subscription for an available subscription merchandise in a multi-subscription service according to an example embodiment;

FIG. 4 is a diagram illustrating an example of a subscription activation based on an authentication state of a user account in a multi-subscription service according to an example embodiment:

FIG. 5 is a diagram illustrating an example of a banner exposure of an available subscription merchandise in a multi-subscription service according to an example embodiment;

FIG. 6 is a diagram illustrating an example of providing subscription information in a multi-subscription service according to an example embodiment; and

FIG. 7 is a diagram illustrating an example of keeping subscription information when a regular payment is unsuccessful in a multi-subscription service according to an example embodiment.

### DETAILED DESCRIPTION

The following structural or functional descriptions of example embodiments described herein are merely intended for the purpose of describing the example embodiments described herein and may be implemented in various forms. However, it should be understood that these example embodiments are not construed as limited to the illustrated forms.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components. In addition, it should be noted that if it is described in the specification that one component is “directly connected” or “directly joined” to another component, still other component may not be present therebetween. Likewise, expressions, for example, “between” and “immediately between” and “adjacent to” and “immediately adjacent to” may also be construed as described. in the foregoing.

Hereinafter, example embodiments will be described in detail with reference to the accompanying drawings. When describing the example embodiments with reference to the accompanying drawings, like reference numerals refer to like components and a repeated description related thereto will be omitted.

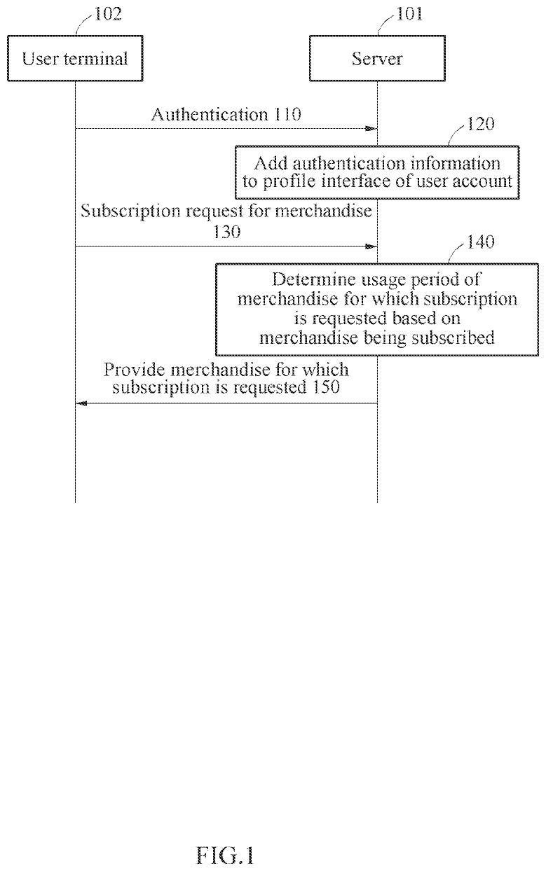

FIG. 1 is a diagram illustrating an example of a method of providing a multi-subscription service according to an example embodiment.

Referring to FIG. 1, a server 101 may provide an instant messaging service (IMS) or a social networking service (SNS).

A user terminal 102 may be one of electronic devices including a computer, a portable computer, a wireless phone, a mobile phone, a smart phone, a personal digital assistant (PDA), a web tablet, and the like. The user terminal 102 may be any device that may install and execute a service application related to the server 101. Here, the user terminal 102 may perform overall service operations such as service screen configuration, data input, data transmission and reception, and data storage under a control of the application. For example, the user terminal 102 may access the server 101 through the service application.

A user account may be generated by subscribing to a service provided by the server 101, and the server 101 may serve as a service platform that provides services to the user account being subscribed to services including an SNS and an IMS. Since a user account is used to provide a service through the user terminal 102, a user account included in the following example embodiments may be construed as representing the user terminal 102. A user may create a profile corresponding to the user account, which includes identification information of the user through the server 101. The profile corresponding to the user account may be displayed on the user terminal 102 through a profile interface. To be described hereinafter, authentication information may be added to the profile corresponding to the user account.

A method of providing a multi-subscription service performed by the server 101 may include operation 110 performing authentication, operation 120 adding authentication information to a profile interface of the user account, operation 130 receiving a subscription request for a merchandise, operation 140 determining a usage period of the merchandise for which a subscription is requested based on the merchandise currently being subscribed, and operation 150 providing the merchandise for which the subscription is requested.

In operation 110, a subscribed user may perform authentication to the server 101 through the user terminal 102. Authentication may represent an operation of authenticating whether personal information input by a user and preregistered personal information of a service user correspond to each other. For example, authentication may include a mobile phone authentication, which verifies a name acid resident registration number of an actual user input by a user by transmitting, by the server 101, an authentication number to the user terminal 102 activated by a name of a service user, and an authentication, which uses a certificate issued in the name of the service user. A certificate may be an electronic certificate in which subject information is added to a public key (e.g., digital signature verification information) required for identity verification and an electronic signature in an electronic transaction, and include an official authentication certificate, a joint authentication certificate, a browser certificate, and the like.

The server 101 may obtain the authentication information corresponding to the user account through user authentication, and store and manage the obtained authentication information corresponding to the user account. The authentication information may include authenticated personal information based on the user authentication. For example, the authentication information may include authenticated real name information and authenticated s eligibility information. The authenticated real name information may correspond to a real name of the user authenticated through authentication. The authenticated eligibility information may verify identity, status, and ability of a user represented in the user account. For example, the authenticated eligibility information may include a driver's license, a student ID, an employee ID, and other certifications.

In operation 120, the server 101 may add the authentication information to the profile of the user's authenticated user account, and the user terminal 102 may display the authentication information added to the profile in a profile interface.

In operation 130, the server 101 may receive a subscription request for a target merchandise from the user terminal 102. The user terminal 102 may transmit the subscription request for the target merchandise of the user account to the server 101. The server 101 may accept the subscription request of the user account in response to authentication of the user account. The server 101 may deny the subscription request of a non-authenticated user account.

In operation 140, the server 101 may determine a usage period of a merchandise for which the subscription is requested. For example, in response to the subscription request being received, the server 101 may query another merchandise to which the user account is currently subscribing. In response to the other merchandise being queried, the server 101 may determine the usage period of the target merchandise to which the subscription is requested based on the usage period of the queried merchandise. The server 101 may calculate a payment amount for an initial subscription of the target merchandise based on a determined usage period and send a request to pay the payment amount to the user terminal 102. The user terminal 102 may perform a process of paying the payment amount for the initial subscription of the target merchandise.

An initial subscription described herein may be an operation of initially subscribing to an available subscription merchandise, and a regular subscription described herein may be an operation of renewing a subscription performed after the operation of initial subscription regularly. An available subscription merchandise described herein may be a merchandise that may be available to be subscribed to and provided by the server, and a target merchandise described herein may be a merchandise selected as a merchandise to be subscribed by a user to account among one or more available subscription merchandises.

In operation 150, the server 101 may provide the target merchandise for which the subscription is requested among the one or more available subscription merchandises. For example, the server 101 and/or the user terminal 102 may provide the target merchandise for which the subscription is requested to the user terminal 102 in response to a payment by the user terminal 102 being approved.

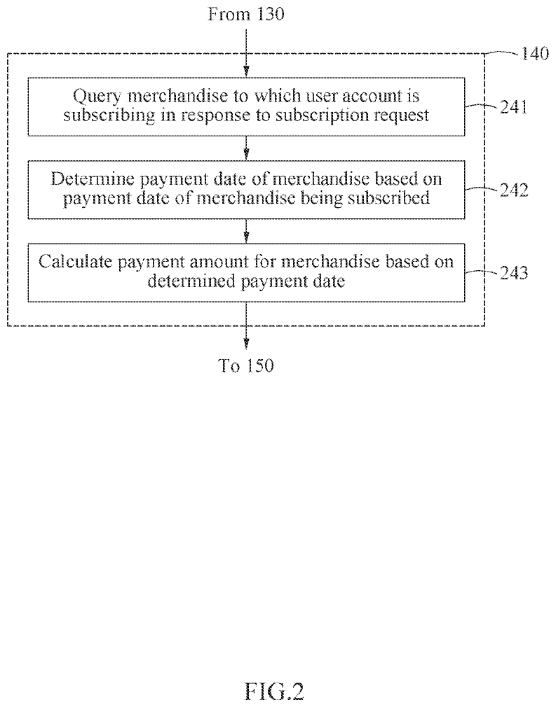

FIG. 2 is a diagram illustrating an example of a method of providing a multi-subscription service according to an example embodiment.

Operation 140 may include querying a merchandise to which the user account is currently subscribing in response to a subscription request in operation 241, determining a payment date of the merchandise based on a payment date of the merchandise currently being subscribed determined in operation 242, and calculating a payment amount for the merchandise based on the payment date determined in operation 243.

In operation 241, when the subscription request is received from a user terminal, a server may query a merchandise to which the user account is currently subscribing. For example, the user account may be currently subscribing to some merchandises among a plurality of available subscription merchandises. The server may extract a payment date of the merchandise to which the user account is currently subscribing, In another example, the server may skip operations 242 and 243 and determine the payment date of a target merchandise to which the user account is currently subscribing in response to said target merchandise not being queried. Since the user account possibly may not subscribe to all available subscription merchandises, the payment date of the merchandise for which the subscription is requested may be determined independently.

In operation 242, the server may determine the payment date of the target merchandise based on the payment date of another merchandise currently being subscribed to. The payment date of the other merchandise currently being subscribed to may be determined based on an end date of a usage period of the merchandise currently being subscribed to. For example, the payment date of the merchandise currently being subscribed to may be set to the same date as an end date of a usage period of the other merchandise. A payment date of a merchandise currently being subscribed to being the same as the end date of a usage period is described herein as a main example, but is not limited. thereto. The payment date of the merchandise currently being subscribed to may be a date close to an end date of a usage period (e.g., one day before the usage period ends), a dale determined by a user and/or a service provider (e.g., a server operator), and a date determined to be apart by a preset period (e.g., one week before the usage period ends).

In addition, the end date of the usage period of the merchandise being subscribed to may be determined based on one of a payment date determined by the user and a payment date determined by the server. For example, an end date of the usage period of another merchandise currently being subscribed to may be determined by the server or the user based on a payment date on which an initial subscription is made for the other merchandise. In another example, a user may change the end date and the payment date of the usage period of the other merchandise to a desired date in a subscription period for the other merchandise.

In this example, the server may determine the end date of the usage period of the target merchandise to he the same date as the end date of the usage period of the other queried merchandise. That is, the server may match the end date of the target merchandise for which a new subscription is requested and the end date of the other merchandise to which the user account is already subscribing. For reference, until the user account cancels the subscription, the usage period of the merchandise being subscribed to may be extended by a preset period (e.g., one month) whenever an end date is reached and a regular payment is successful.

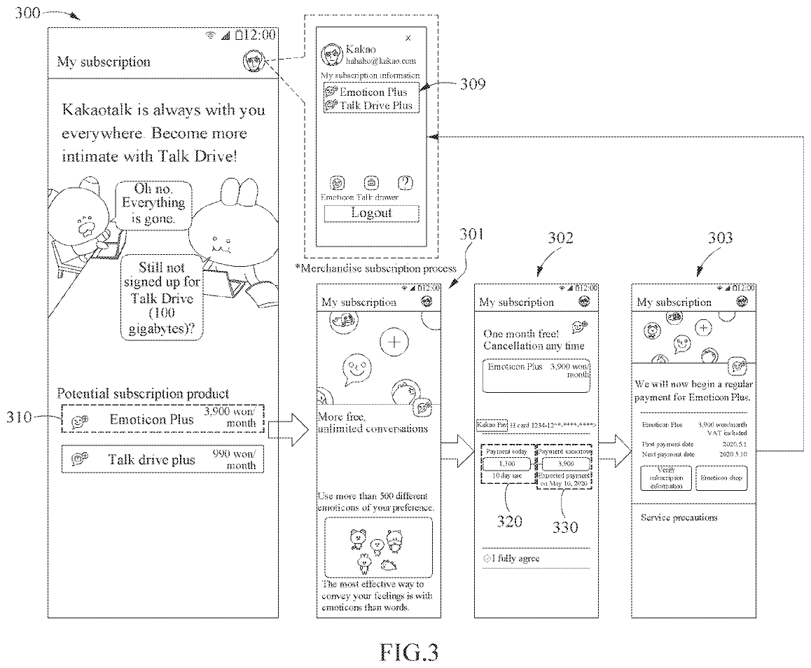

In operation 243, the server may calculate a payment amount for a merchandise (e.g., a target merchandise and/or another merchandise) based on the payment date determined in operation 242. For example, the server may calculate the payment amount for the initial subscription of the target merchandise based on the subscription charge determined for the preset period of the target merchandise and a period from a start date of the target merchandise to an end date of the subscription usage period of the target merchandise. The preset period of the target merchandise may be a time interval determined between regular payment dates. For example, the preset period may be one month (or 30 days), but is not limited thereto. A period from the start date of the target merchandise to the end date of the subscription usage period of the target merchandise may be represented as an initial subscription period, and the initial subscription period may have a time length equal to or less than the usage period. The server may calculate the payment amount for the initial subscription by dividing a subscription payment amount determined for the preset period by the initial subscription period. An example of a daily rate calculation of the payment amount for the initial subscription is described with reference to FIG. 3.

Thus, a usage period of a multi-subscription of the user account and/or a regular payment date based on the multi-subscription may be collectively and conveniently managed in an integrated manner.

In another example, the server may request an integrated payment for each theme from a user terminal being currently subscribed to a plurality of merchandises. The server may classify the plurality of merchandises by theme. For example, the server may classify some merchandises among the plurality of merchandises as a first theme (e.g., a content related theme) and classify other merchandises as a second theme (e.g., a storage related theme). Examples of a content related theme and a storage related theme are described herein, but the examples are not limited thereto. The server may integrate a payment amount for each theme. For example, the server may determine a payment amount for a first payment by adding a payment amount for some subscription merchandises belonging to the first theme and adding a payment amount for other subscription merchandises belonging to the second theme. The server may separately request the first payment for a merchandise group belonging to the first theme and a second payment for a merchandise group belonging to the second theme among the plurality of merchandises to which the user account is currently subscribing. A payment date of the first payment and a payment date of the second payment may be determined to be different or the same. The user terminal may perform a payment process for each theme requested from the server. Thus, a user may process a payment for each theme by an integrated payment process for each theme, instead of paying for all the subscribed merchandises at once.

FIG. 3 is a diagram illustrating an example of determining a payment amount and a payment date of an initial subscription for an available subscription merchandise in a multi-subscription service according to an example embodiment.

According to an example embodiment, a server and/or a user terminal may provide a subscription guide interface 300 that guides the user to available subscription merchandises. The subscription guide interface 300 may include a list of the available subscription merchandises. For example, the subscription guide interface 300 may display a name and a monthly payment amount of an available subscription merchandise.

When a graphic representation 310 indicating the target merchandise from the list of the available subscription merchandises is selected and detected, the user terminal may switch to an interface 301 that presents an additional description of the selected target merchandise. The interface 301 may include a content description (e.g., emoticons) and/or access to additional services (e.g., adding cloud storage capacity) provided through a subscription to the target merchandise. An “Emoticon Plus” merchandise illustrated in FIG. 3 may be a merchandise that provides paid emoticons as a subscription service, and a “Talk Drawer Plus” merchandise may be a merchandise that adds a cloud storage capacity used for an SNS.

The user terminal may switch to a payment interface 302 after the user verifies the interface 301. The payment interface 302 may include payment method information, payment information 320 for the initial subscription, arid payment information 330 for the regular subscription. The payment method information may be associated with a payment process for the initial subscription and the regular subscription. For example, the payment method information may include information associated with a credit card, a debit card, a bank automatic transfer, a mobile phone micropayment and a simple payment service (e.g., Kakao Pay, etc. For example, in case of the credit card and/or the debit card, payment method information may include at least a part of a card serial number of the credit card and/or the debit card and information related to a card company. In another example, in case of a bank automatic transfer, payment method information may include an account number and information related to a bank. In yet another example, in case of the mobile phone micropayment, payment method information may include at least a part of a phone number of the mobile phone and information associated with a telecommunication company.

The payment information 320 for the initial subscription may include a usage period of the initial subscription and a payment amount for the initial subscription. Payment information 330 for the regular subscription may include a subsequent regular payment date of the regular subscription and a payment amount for the regular subscription. An end date of the usage period of the initial subscription of the target merchandise may be determined to be the same as an end date of the usage period of another queried merchandise currently being subscribed to. In addition, the payment amount for the initial subscription of the target merchandise may be calculated based on a subscription payment amount determined for a preset period of the target merchandise and a period from a start date of the target merchandise to an end date of a subscription usage period of the target merchandise.

In this example, the server may transmit payment information for the initial to subscription and the regular subscription to the user terminal. As illustrated in FIG. 3, the user terminal may output the payment information for the initial subscription and the regular subscription through the payment interface 302. The user terminal may output the payment amount for the initial subscription of the target merchandise with the usage period of the target merchandise. Here, the user terminal may output the payment amount for the regular subscription of the target merchandise after the initial subscription with a subsequent regular payment date. Thus, the server and/or the user terminal may intuitively inform the user of the cost and a payment due date for a subsequent regular subscription with the cost and the usage period for the initial subscription of the target merchandise at the time of the initial subscription.

For example, the subscription start date of the target merchandise may be May 1, 2020, the end date of the usage period of other regular subscription merchandises may be May 10, 2020, and the subsequent regular payment date may be May 5, 2020, as illustrated in FIG. 3. The server may calculate the usage period (e.g., an initial subscription period) for the initial subscription of the target merchandise as 10 days. The payment amount for the regular subscription may be determined at 3,900 won (KRW for a preset period of 30 days. The server may calculate a payment amount of 1,300 KRW for an initial subscription period of 10 days by dividing the payment amount of 3,900 KRW determined for the set period of 30 days to the initial subscription period of 10 days. The user terminal may output the payment amount of 1,300 KRW for the initial subscription and the initial subscription period of 10 days as payment information 320 for the initial subscription to the payment interface 302. In addition, the user terminal may output the payment amount of 3,900 KRW for the regular subscription and the subsequent regular payment date of May 10, 2020, as the payment information 330 for the regular subscription to the payment interface 302.

The server and/or the user terminal may switch to a payment completion interface 303 in response to a payment for the target merchandise being approved and provide a payment result to the user. The server and/or the user terminal may provide a list of merchandises to which the user account is currently subscribing in an additional interface 309.

In an example, a first discount rate for the initial subscription and a second discount rate for the regular subscription may be determined based on a subscription combination of the target merchandise and the other merchandise currently being subscribed to. For example, the server may determine the first discount rate for the initial subscription and the second discount rate for the regular subscription based on the subscription combination of the target merchandise and the other merchandise currently being subscribed to based on a policy and/or marketing of a service provider. The first discount rate and the second discount rate may be different based on the target merchandise that is combined with the other merchandise being currently subscribed to. For example, when a first merchandise is combined with the other merchandise being currently subscribed to, the first discount rate may be determined as X1%, and the second discount rate may be determined as Y1%. When a second merchandise is combined with the other merchandise being currently subscribed to, the first discount rate may be determined as X2% and the second discount rate may be determined as Y2%. X1 and X2 may be real numbers and be different from each other, and Y1 and Y2 may be real numbers and be different from each other. The first discount rate and the second discount rate may be different from each other, or the first discount rate and the second discount rate may be the same. An example of two combined merchandises is described herein, but the example is not limited thereto. Three or more merchandises may be combined. In addition, a discount rate may be determined based on the number of merchandises in the subscription combination. For example, a discount rate may increase as the number of merchandises in the subscription combination increases.

The server may request a payment amount obtained by applying the first discount rate to the payment amount for the initial subscription of the target merchandise to the user terminal. The user terminal may process the payment amount obtained by applying the first discount rate to the payment amount for the initial subscription of the target merchandise,

In addition, the user terminal may request a regular payment amount obtained by applying the second discount rate to the payment amount for the regular subscription of the subscription combination. When the regular payment is approved, a preset amount may be paid regularly. For example, the server may request a payment amount obtained by applying a second discount rate to the payment amount for the regular subscription of the subscription combination regularly. The server may request a payment amount to which the second discount rate is applied from a card company server and/or a bank server regularly. Thus, the user may subscribe to a merchandise at a low cost, which is discounted based on the subscription combination, and the service provider may induce a subscription of a desired merchandise (e.g., a promotional target merchandise).

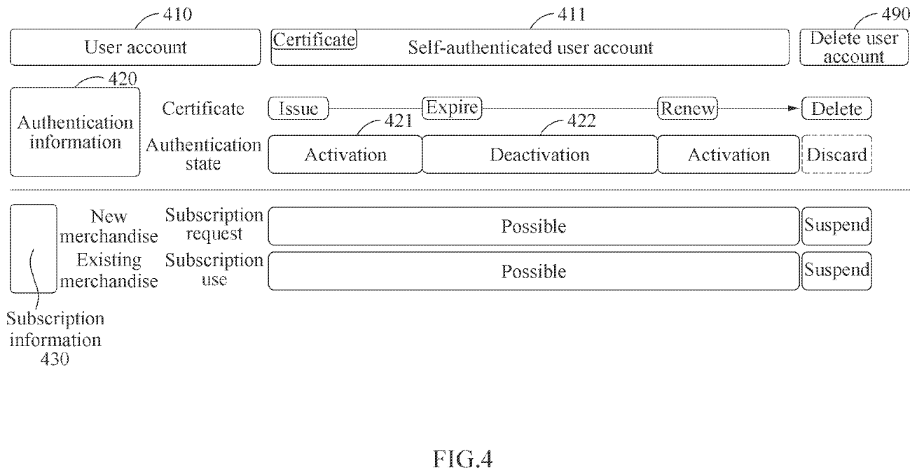

FIG. 4 is a diagram illustrating an example of a subscription activation based on an authentication state of a user account in a multi-subscription service according to an example embodiment.

According to an example embodiment, a server may limit a user account 410 by allowing the user account 410 to subscribe before authentication is complete and accept (or allow) a subscription to an authenticated user account 411.

The server may add authentication information 420 to the authenticated user account 411. After a certificate is issued to the user account, the server may maintain the authentication information 420 until deletion 490 of the user account is performed. Activation 421 of an authentication state of the user account may be performed by the server when the certificate is valid and deactivation 422 of the authentication state of the user account may be performed by the sever when the certificate is invalid. When the deletion 490 of the user account is performed, the authentication state of the user account may be discarded by the to server. When the certificate issued to the user account expires, the deactivation 422 of the authentication state may be performed by the server. However, when the certificate issued to the user account is renewed, reactivation 421 of the deactivation 422 of the authentication state may be performed by the server. The authentication information 420 added to the user account may be maintained by the server even after the deactivation 422 of the authentication state is performed.

When a subscription request is received from a user terminal, the server may accept the subscription request for a target merchandise in response to an authentication of the user account. The server may also accept the subscription request in a period after the certificate used to authenticate the user account has expired and before the certificate is renewed. In addition, the server may continue to provide the authenticated user account 411 with access to a merchandise currently being subscribed to in the period after the certificate used to authenticate the user account has expired and before the certificate is renewed. The subscription information 430 may include information associated the merchandise to which the authenticated user account 411 is currently subscribing and a subscription-related authority. The subscription-related authority may include authority to apply for a new subscription to the target merchandise among a plurality of available subscription merchandises and/or authority to maintain a subscription to the other merchandise currently being subscribed to.

Thus, the server and/or the user terminal may maximize user convenience by maintaining the new subscription and an existing regular subscription of the user account even when the certificate issued to the user account has temporarily expired.

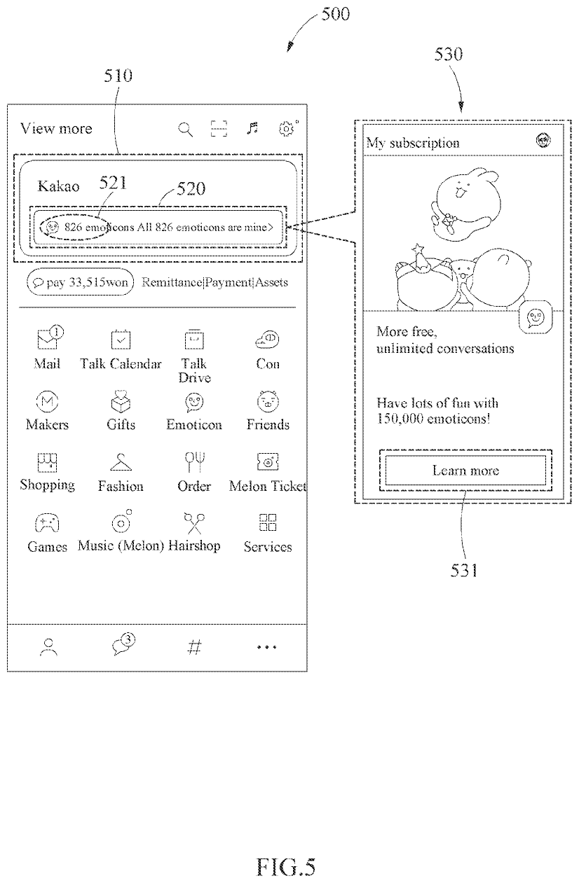

FIG. 5 is a diagram illustrating an example of a banner exposure of an available subscription merchandise in a multi-subscription service according to an example embodiment.

According to an example embodiment, a server may provide a merchandise to which a user account is subscribing among a plurality of available subscription merchandises to be exposed in association with a profile interface of the user account. For example, the server may query the merchandise to which the user account is subscribing among the plurality of available subscription merchandises and extract a merchandise 521 to which the user account is not subscribing. The server may provide the extracted merchandise 521 to a user terminal to be exposed in association with the profile interface of the user account.

The user terminal may provide information associated with the profile interface and the merchandise 521 in an interface 500 as an additional function. For example, a display of the user terminal may expose an available subscription merchandise provided by the server in an area associated with the profile interface of the user account. The user terminal may receive information associated with the merchandise 521 to which the user account is not subscribed from the server. The user terminal may output the profile interface on a profile area 510 on the display. The user terminal may output information associated with the extracted merchandise 521 to a partial area (e.g., a banner area) 520 in the profile area 510. When a plurality of merchandises 521 are present, the user terminal may select some merchandises among the plurality of merchandises 521 and expose the selected merchandises in the partial area 520. Only one emoticon merchandise is exposed as illustrated in FIG. 5, but the number is not limited thereto. Two or more merchandises 521 may be exposed. However, when the user account is subscribing to all the available subscription merchandises, the server and/or the user terminal may stop exposing (or outputting) the subscription merchandises in the partial area 520 of a mobile application.

The user terminal may provide an interface 530 for the merchandise 521 in response to an input to the partial area 520 allocated for an advertisement of the merchandise 521 being received. The user terminal may provide summary information associated with the selected merchandise 521 through the interface 530. The user terminal may provide detailed information associated with the merchandise 521 in response to an additional information request object 531 (illustrated in FIG. 5 as “Learn more”) included in the interface 530 being selected. For example, the user terminal may provide one of detailed information including a payment link and detailed information excluding a payment link.

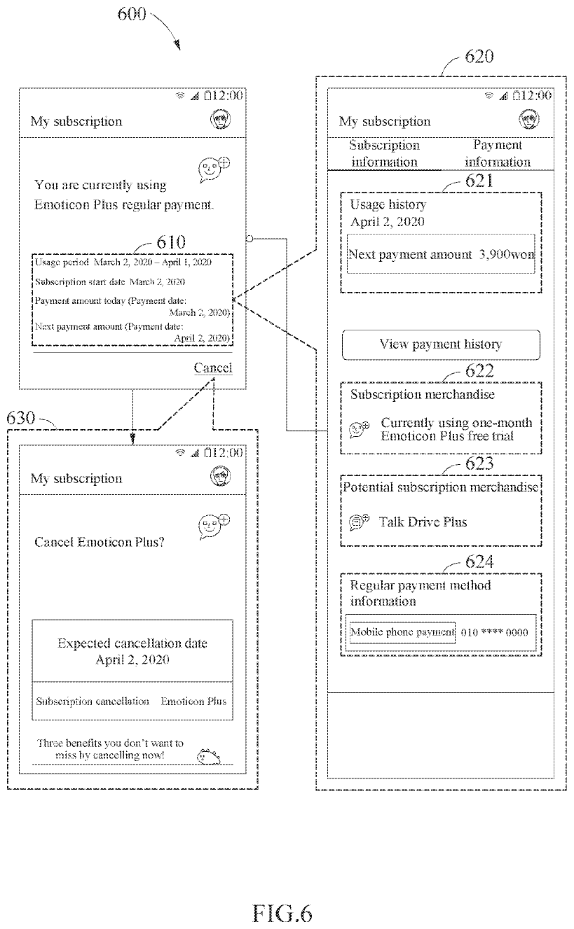

FIG. 6 illustrates an example of providing subscription information in a multi-subscription service according to an example embodiment.

According to an example embodiment, a server and/or a user terminal may provide merchandise information 610 of a merchandise being currently subscribed to in a subscription interface 600. The merchandise information 610 of the merchandise being currently subscribed to may include an expiration date for the merchandise currently being subscribed to, a subscription start date, a current payment amount, and a subsequent payment amount.

The server and/or the user terminal may notify the user of an expected cancellation date by a cancellation interface 630 when cancellation of the merchandise currently being subscribed to is requested. The scheduled cancellation date may be determined based on a regular payment date, but the date is not limited thereto. The scheduled cancellation date may be determined by a user. In addition, the user may immediately cancel the merchandise being currently subscribed to.

The server and/or user terminal may provide the subscription information to the user. The subscription information interface 620 may separately provide usage history 621 of a user account, subscription merchandise information 622, available subscription merchandise information 623, and regular payment method information 624. The usage history 621 may include a total payment amount based on a combination of merchandises to which the user account is currently subscribing and a payment due date, The subscription merchandise information 622 may include a list of merchandises to which the user account is currently subscribing. The available subscription merchandise information 623 may include a list of merchandises to which the user account is not subscribing. The regular payment method information 624 may include information associated with a payment method determined for a regular payment.

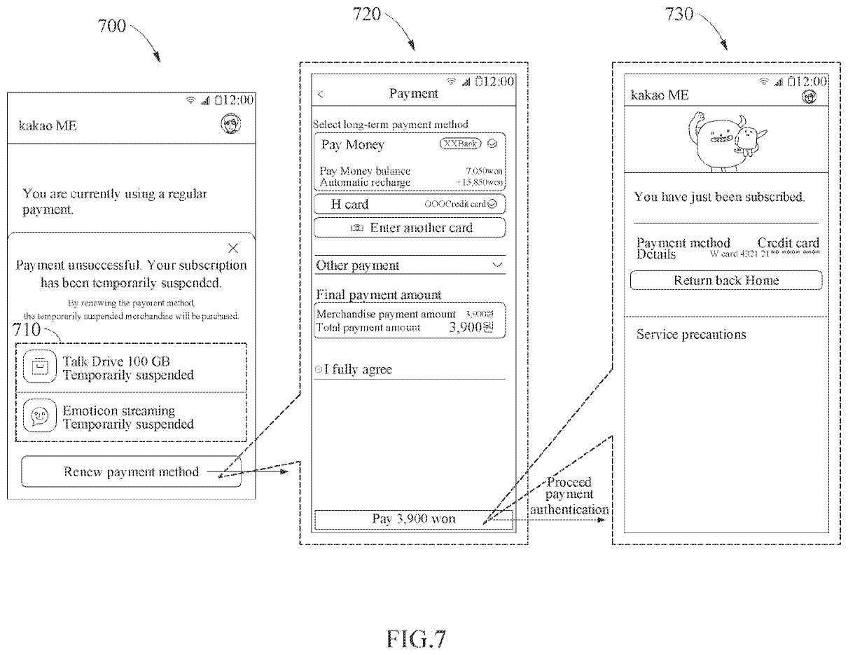

FIG. 7 is a diagram illustrating an example of keeping subscription information when a regular payment is unsuccessful in a multi-subscription service according to an example embodiment.

According to an example embodiment, a server and/or a user terminal may stop a provision of a merchandise to which the user account is subscribing while keep subscription information associated with a merchandise to which the user account is currently subscribing in response to a payment failure by a payment method registered in the user account on a regular payment date. For example, as illustrated in FIG. 7, the server and/or the user terminal may provide a list 710 of merchandises currently being subscribed to that are to be temporarily suspended and a guide interface 700 for a payment method reregistration when a payment is unsuccessful. The merchandises currently being subscribed to in the list 710 may be temporarily suspended from the date after the payment failure date.

In addition to a payment method registered for a regular payment, the server and/or the user terminal may provide a list of other payment methods in a payment method reregistration interface 720. The server and/or the user terminal may request that a user register a new payment method. The server and/or the user terminal may facilitate the start of a subscription and provide information associated with the payment method registered for the subscription in a subscription resumption interface 730. The server and/or the user terminal may resume subscription of a merchandise that was temporarily suspended when a payment method is reregistered.

Thus, the method for providing a multi-subscription service may induce the user to immediately switch to another available payment method when a payment is unsuccessful, thereby providing the user with a consistent subscription to the merchandise and preventing the payment from being delayed.

According to an example embodiment, a server providing a multi-subscription service may include a communicator, a memory, and a processor. The communicator may receive a subscription request for a target merchandise from a user terminal. The memory may store subscription information associated with a subscription of the user account. The processor may query another merchandise to which the user account is currently subscribed from the subscription information in response to the subscription request being received. The processor may determine a usage period of the target merchandise for which subscription is requested based on a usage period of other queried merchandise in response to the other queried merchandise being an already subscribed-to merchandise. The processor may calculate a payment amount for an initial subscription of the target merchandise based on a determined usage period and request a payment of the calculated payment amount to the user terminal. The processor may provide the target merchandise to the user terminal in response to the payment by the user terminal being approved.

According to an example embodiment, a user terminal providing a multi-subscription service may include a communicator, a memory, a display, and a processor. The communicator may transmit a subscription request for a target merchandise of the user account to the server. The processor may perform a process of paying a payment amount for an initial subscription of the target merchandise. The processor may provide the target merchandise to the user terminal in response to the payment by the user terminal being approved. The memory may store user account information, subscription information, payment information, and the like. The display may be implemented as, for example, a touch display and receive an input (e.g., touch input) related to a multi-subscription service or visually output information related to the multi-subscription service. to Descriptions of operations of each component of the server and the user terminal is not limited to the descriptions represented above, and the description of the operations represented above with reference to FIGS. 1 to 7 may also apply to the server and the user terminal.

The example embodiments described herein may be implemented using hardware components, software components, or a combination thereof. A processing device may be implemented using one or more general-purpose or special purpose computers, such as, for example, a processor, a controller and an arithmetic logic unit (ALU), a digital signal processor (DSP), a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired, Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described example embodiments may be recorded in non-transitory computer-readable media including program instructions to implement various operations which may be performed by a computer. The media may also include, alone or in combination with the program instructions, data files, data. structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described example embodiments, or vice versa.

While this disclosure includes example embodiments, it will be apparent to one of ordinary skill in the art that various changes in form and details may be made in these example embodiments without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of providing a multi-subscription service performed by a server, comprising:
receiving a subscription request for a target merchandise from a user terminal;
querying another merchandise to which a user account is subscribing in response to the subscription request being received;
determining a usage period of the target merchandise for which a subscription is requested based on a usage period of the other merchandise in response to the other merchandise being queried;
calculating a payment amount for an initial subscription of the target merchandise based on the determined usage period;
requesting a payment of the calculated payment amount by the user terminal; and
providing the target merchandise to the user terminal in response to the payment by the user terminal being approved.

2. The method of claim 1, wherein the determining of the usage period comprises:
determining an end date of the usage period of the target merchandise to be a same date as an end date of the usage period of the other queried merchandise.

3. The method of claim 2, wherein the requesting of the payment of the calculated payment amount comprises:
calculating the payment amount for the initial subscription of the target merchandise based on a subscription charge determined for a preset period of the target merchandise and a period from a subscription start date of the target merchandise to an end date of the usage period of the target merchandise.

4. The method of claim 2, wherein the end date of the usage period of the other merchandise is determined based on one of a payment date determined by a user or a payment date determined by a server.

5. The method of claim 1, wherein the receiving of the subscription request comprises:
accepting the subscription request for the target merchandise in response to an authentication of the user account.

6. The method of claim 5, wherein the accepting of the subscription request comprises:
accepting the subscription request in a period after a certificate used for the authentication of the user account has expired and before the certificate is renewed.

7. The method of claim 1, further comprising:
exposing a merchandise available to be subscribed by the user account among a plurality of merchandises by being associated with a profile interface of the user account.

8. The method of claim 1, further comprising:
stopping a provision of a merchandise to which the user account is subscribing, while keeping subscription information associated with the merchandise to which the user account is subscribing in response to a payment failure by a payment method registered in the user account on a regular payment date.

9. The method of claim 1, wherein the requesting of the payment of the calculated payment amount comprises:
determining a first discount rate for the initial subscription based on a subscription combination of the target merchandise and the other merchandise to which the user account is subscribing; and
requesting a payment amount obtained by applying the first discount rate to the payment amount for the initial subscription of the target merchandise,
wherein the method further comprises:
determining a second discount rate for a regular subscription based on the subscription combination of the target merchandise and the other merchandise to which the user account is subscribing; and
requesting a payment amount obtained by applying the second discount rate to a payment amount for the regular subscription of the subscription combination regularly.

10. A non-transitory computer-readable storage medium storing instructions that, when executed by a processor, cause the processor to perform the method of claim 1,

11. A method of providing a multi-subscription service per by a user terminal, comprising:
transmitting a subscription request for a target merchandise of a user account to a server;
performing a process of paying a payment amount for an initial subscription of the target merchandise; and
providing the target merchandise to the user terminal in response to a payment by the user terminal being approved,
wherein a usage period of the target merchandise for which a subscription is requested is determined based on a usage period of another merchandise to which the user account is subscribing and is calculated based on a determined usage period for the target merchandise in response to the subscription request.

12. The method of claim 11, wherein an end date of the usage period of the target merchandise is determined to be a same date as an end date of the usage period of the other merchandise.

13. The method of claim 12, wherein the performing of the payment process comprises:
outputting the payment amount for the initial subscription of the target merchandise with the usage period of the target merchandise; and
outputting a payment amount for a regular subscription for the target merchandise with a subsequent regular payment date after the initial subscription,
wherein the payment amount for the initial subscription of the target merchandise is calculated based on a subscription charge determined for the target merchandise for a preset period and a period from a subscription start date of the target merchandise to an end date of the usage period of the target merchandise.

14. The method of claim 12, wherein the end date of the usage period of the other merchandise is determined based on one of a payment date determined by a user or a payment date determined by a server.

15. The method of claim 11, wherein the subscription request for the target merchandise is accepted in response to an authentication of the user account.

16. The method of claim 15, wherein the subscription request is accepted in a period after a certificate used for the authentication of the user account has expired and before the certificate is renewed.

17. The method of claim 11, further comprising:
exposing a merchandise, available to be subscribed by the user account among a plurality of merchandises, in an area associated with a profile interface of the user account.

18. The method of claim 11, wherein subscription information associated with a merchandise to which the user account is subscribing is kept and a provision of the merchandise subscribed by the user account is stopped in response to a payment failure by a payment method registered in the user account on a regular payment date.

19. The method of claim 11, wherein a first discount rate fir an initial subscription and a second discount rate for a regular subscription are determined based on a subscription combination of the target merchandise and the other merchandise being subscribed to,
wherein the performing of the payment process comprises:
processing a payment amount obtained by applying the first discount rate to the payment amount for the initial subscription of the target merchandise,
wherein the method further comprises:
requesting a payment amount obtained by applying the second discount rate to a payment amount for the regular subscription of the subscription combination regularly.

20. A server for providing a multi-subscription service, comprising:
a communicator configured to receive a subscription request for a target merchandise from a user terminal;
a memory configured to store subscription information associated with a subscription of the user terminal; and
a processor,
wherein the processor is configured to query another merchandise to which a user account is subscribing in response to the subscription request being received, determine a usage period of the target merchandise for which a subscription is requested based on a usage period for the other queried merchandise in response to the other merchandise being queried, calculate a payment amount for an initial subscription of the target merchandise based on the determined usage period, request a payment the calculated payment amount by the user terminal, and provide the target merchandise to the user terminal in response to the payment by the user terminal being approved.
